(19) United States
(12) Patent Application Publication
(10) Pub. No.: US 2009/0146407 A1
(43) Pub. Date: Jun. 11, 2009

(54) Heat shrinkable book cover

(76) Inventor: Ronald Reda, Chicago, IL (US)

Correspondence Address: SEYFARTH SHAW LLP, 131 S. DEARBORN ST., SUITE 2400, CHICAGO, IL, 60603-5803, US

(21) Appl. No.: 12/077,021

(22) Filed: Mar. 14, 2008

Related U.S. Application Data
(60) Provisional application No. 61/005,623, filed on Dec. 6, 2007.

(51) Int. Cl. B42D 3/18; B31B 1/14

(52) U.S. Cl. 281/31; 493/340

(57) ABSTRACT

A flexible heat shrinkable plastic book cover with two pockets allowing the front and back cover of the book to slide into. Once the covers are within their sleeves hot air is applied from a hair dryer, heat gun or other heat emitting air flow device. When the hot air comes into contact with the heat sensitive plastic wrap it causes it to shrink and form itself snuggly around the book creating a sealed membrane around the outer cover of the book. Said cover may or may not have printing and or graphics on and about the cover and inside the cover.

The present application claims priority to provisional application Ser. No. 61/005,623, filed Dec. 6, 2007.

### TECHNICAL FIELD

This invention relates to the field of protective covers for books and other published or printed material bound together.

### BACKGROUND OF THE INVENTION

Prior art in this field involves the sizing and cutting of plastic sheets, brown kraft paper or used brown grocery bags to the size of the book to be covered. Once sized the sheets are then taped to the book or some sort of adhesion is used to hold the sheets in place on the book. This is done extensively by libraries and school kids often mandated by the schools. This method and the materials available were never meant for the task they are being used for nor do they properly do the job. Such methods leave many openings in the cover and around the edges allowing dirt and liquids to enter. Such a method actually leaves yellow marks on the books and degrades them over time and does not last very long and needs to be replaced often. Such prior known methods are also very time consuming to achieve.

The present invention is provided to solve the problems discussed above and other problems, and to provide advantages and aspects not provided by prior book covers of this type. A full discussion of the features and advantages of the present invention is deferred to the following detailed description, which proceeds with reference to the accompanying drawings.

### SUMMARY OF THE INVENTION

This invention solves all these problems by using a one-piece plastic membrane with two pockets, one for the front cover and one for the back cover to enter, these pockets cover all of the books cover inside and out instead of only a partial cover as in the current art. Once the books front and back cover have been slipped into the sleeves of the membrane hot air is then applied with a common hair dryer or other hot air emitting device, when the hot air makes contact with the heat sensitive plastic it causes it to shrink around the book. This new invention greatly improves the accuracy, protection, and speed of applying book covers. This invention also improves the long term quality of the book and its binder because there are no adhesives used in the process. Furthermore this invention requires very little skill to apply; any child or adult could apply this cover in minutes. This invention may also have printing of words and/or graphics on it to be used as the books illustrated cover instead of the current paper covers that are on books when you buy them from the store. This cover would eliminate the paper illustrated cover and combine the graphics and wording to become the new 1 piece membrane cover. This would be applied right from the publisher before it was sent to the stores.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of the shrink wrap tubing prior to being rolled down flat to form the book covers of the present invention;

FIG. 2 is a side elevation view of the book cover invention;

FIG. 3 is a plan view of a sheet of shrink wrap film prior to being folded to form the book cover invention;

FIG. 4 is a side elevation view of the flat shrink wrap film of FIG. 3 after it has been folded and all edges have been heat sealed to form the pockets;

FIG. 5 is an isometric view of the shrink wrap book cover invention being applied to a book jacket; and

FIG. 6 is an isometric view of the shrink wrap book cover.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

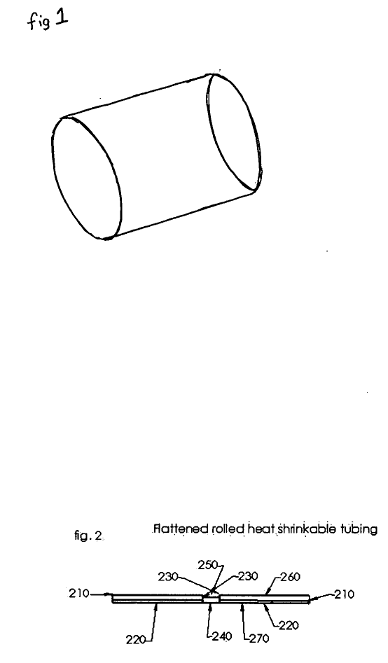

As illustrated in FIG. 1 in one embodiment of the present invention a heat shrinkable poly tube is shown in its circular state prior to being rolled down through a series of rollers to a flat state. Poly tubing is rolled down flat then the center of the top sheet is cut out to form open pockets. A heated wire/knife or bar is then passed through or on top of the poly to form the heat sealed edge. In an embodiment the material may be polyethylene, polypropylene or PVC that provides for 30-40% shrinkage.

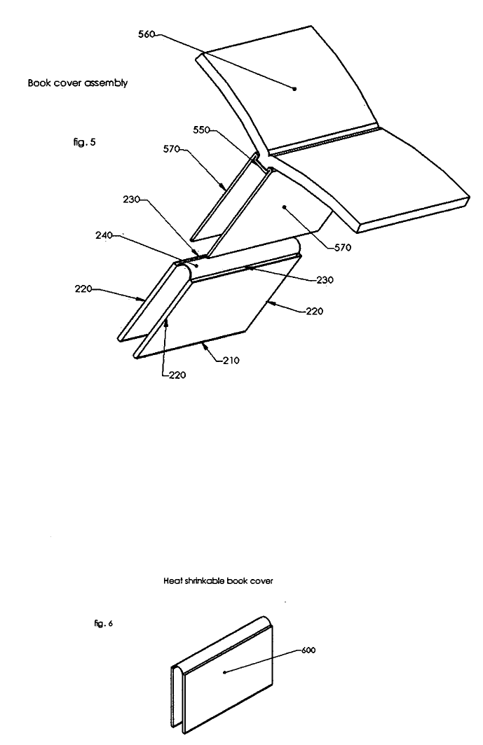

As illustrated in another embodiment FIG. 2 in preparation to having a slit 250 cut into the upper portion 260 in the later stages as the flat tubing rolls through the rollers. By cutting this slit 250 into the upper portion 260 the book cover FIG. 2 is left with a single layer 240 to cover the outer portion 550 of the spine and books cover. This allows for a smooth and consistent single layer across the entire outer portion of the book. As the flat tubing FIG. 2 rolls through the rollers a hot wire, knife, bar or the like cuts and seals a pre-determined distance of flat tubing resulting in the singular book cover unit and thereby forms four of the sealed edges 220 of the two pockets. The outer perimeter is a combination of a sealed edge 220 and a folded edge 210. These 3 outer edges form a one pieces sealed membrane for the books cover to enter FIG. 5 Different sizes of said invention FIG. 5 could be used to accurately form the cover of choice for optimum fit of any book or printed bound material.

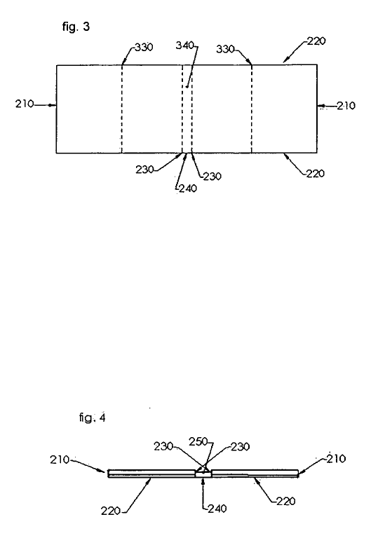

As illustrated in another embodiment FIG. 3 shows a flat sheet of shrink wrap prior to folding. In this FIG. 3 there are pre-determined folds 330 that when folded come up short of each other in the center thereby leaving a gap 340 in the center of the material. This gap 340 leaves a single layer of shrink wrap to cover the spine. This gap 340 also creates the open pocket for the book covers to enter. Said invention 600 is semi loose when first slid onto book jacket 570 560, this loose fit allows for ease of application, once on a heat emitting device such as a hair dryer can now be used to apply hot air to the said invention 600. As the hot air comes in contact with said invention 600 the heat shrinkable film begins to shrink and form itself tightly around the books jacket 570 creating a sealed membrane. Said invention covers entire books jacket 570 from the inside all the way around the outside. The top and bottom seams are then heat sealed to close the pocket. The right and left sides of the pockets are formed by virtue of folding the poly.

As illustrated in another embodiment FIG. 4 is essentially the same as FIG. 3, although coming from different shrink wrap stock, one flat and one is a tube, the end result is the same characteristics.

As illustrated in another embodiment FIG. 5 is the joining of a book and said invention 600. the books jacket 570 is pulled back to about a 90° angle from the pages and inserted into the pocket 230. book is then folded back to normal shape before applying hot air.

As illustrated in another embodiment FIG. 6 is an isometric view of the shrink wrap covers

While the specific embodiments have been illustrated and described, numerous modifications come to mind without significantly departing from the spirit of the invention and the scope of protection is only limited by the scope of the accompanying Claims.

What is claimed is:

1. A protective cover comprising:
a one piece sheet forming a pair of pockets at each end and each pocket including two sealed edges an open side and a folded edge.

2. The cover of claim 1 wherein the folded edge is opposite the open side.

3. The cover of claim 1 wherein the cover forms a first side having a smooth uniform surface and opposite the first side is a second side having pockets and a gap formed between the pockets forming openings in each pocket.

4. The cover of claim 1 wherein each pocket forms a sealed membrane for receiving a book cover.

5. The cover of claim 1 wherein each being formed of a shrinkable film so that when the covering is placed over a book it can be shrunk to form tightly around the book creating a sealed membrane.

6. The cover of claim 1 wherein each cover surrounds the entire book jacket.

7. The cover of claim 1 wherein each being formed of a heat shrinkable material.

8. A method of shrinking a covering unto a book comprising the steps of:
forming a cover having a pair of pockets at each end:
orienting a book so that each book cover is folded back at about a 90 degree angle from the pages;
inserting the book covers into the pockets of the cover; and
applying heat to the cover and shrinking the cover to tightly fit around the book.

9. The method of claim 8 including the step of using a hair dryer to apply heat to the covering.

10. The method of claim 8 comprising the step of placing the book having the cover placed thereon in an oven for applying heat to the cover in order to shrink the cover to the book.

11. A method of fabricating a shrinkable book cover comprising the steps of:
rolling a film through a roller to orient the film in a flat state;
engaging the sides of the film to form a folded portion on each side;
orienting the folded over sides to provide a gap in the center;
cutting the sides of the film using a hot wire to provide sealed edges of the folded sides to form a pair of pockets.

12. The fabrication method of claim 11 further comprising separating the cut section from the roll to form an individual covering.

13. The fabrication method of claim 11 wherein the cutting occurs to form varying sized individual covers.

14. The fabrication method of claim 11 wherein the film begins as a tube shaped polymer.

15. The fabrication method of claim 11 wherein the film has graphic indicia applied thereto.
